(19) United States
(12) Patent Application Publication
(10) Pub. No.: US 2010/0090185 A1
(43) Pub. Date: Apr. 15, 2010

(54) ROADWAY GUARDRAIL SYSTEM AND HANGER

(75) Inventors: Frederick MAUER, Greenland, NH (US); Dallas JAMES, Auckland (NZ); Steven J. CONWAY, Marion, OH (US)

Correspondence Address: HAHN LOESER & PARKS, LLP, One GOJO Plaza, Suite 300, AKRON, OH, 44311-1076, US

(73) Assignee: NUCOR CORPORATION, Charlotte, NC (US)

(21) Appl. No.: 12/367,370

(22) Filed: Feb. 6, 2009

Related U.S. Application Data
(60) Provisional application No. 61/104,871, filed on Oct. 13, 2008.

(51) Int. Cl. E01F 15/00; F16B 45/00

(52) U.S. Cl. 256/13.1; 248/71

(57) ABSTRACT

A roadway guardrail system is disclosed having a plurality of posts capable of supporting at least one rod transverse to the posts, and at least one rod comprising one or more axially extending steel rods supported transverse to the plurality of posts. Each rod may include a plurality of axially extending steel rods supported transverse to the plurality of posts connected in a substantially end to end relationship. The steel rods may be connected using a coupler, and may be welded. The steel rods may be rebar.

### CROSS-REFERENCE AND RELATED APPLICATION

This application claims priority to U.S. provisional patent application Ser. No. 61/104,871, filed on Oct. 13, 2008, the disclosure of which is incorporated herein by reference.

### BACKGROUND AND SUMMARY OF THE DISCLOSURE

The present invention is related to roadway barriers and safety systems, and more particularly, to a roadway guardrail system having a plurality of rods and a plurality of support posts.

Along many roadways it may be hazardous for a vehicle to leave the roadway. As a result, safety barriers, including guardrail systems, are used along roadways. The guardrail systems may act to contain and redirect an errant vehicle along such roadways. Such guardrail systems may dissipate some of the vehicle's energy. One such guardrail system is a cable guardrail system. Cable guardrail systems may reduce the damage caused to impacting vehicles and the injury to vehicle passengers. Compared with W-beam and thrie beam guardrail systems, cable guardrail systems are often more aesthetically appealing and may increase motorist sight distance. Cable guardrail systems also may reduce snow accumulation on adjacent highways and roadways.

A cable guardrail system in the past may have included a plurality of cables secured to a plurality of support posts. Various types of cables and wire ropes have been satisfactorily used for cable guardrail systems. Support posts have been made of wood, metal, or a combination of both. Additionally, cable guardrail systems have included cable anchors that fixed the end of the cables to the ground to maintain tension in the cables. Various types of anchor systems have been used including releasable anchors as described in U.S. Pat. No. 6,065,738 to Pearce.

The number of cables in prior cable guardrail systems has varied depending on factors such as the types of vehicles using the roadway and the types of hazards requiring the guardrail system. Cables have been attached to support posts using various attachment mechanisms. Some attachment mechanisms, such as hook-bolts, were used to attach a single cable to a support post. Another prior attachment mechanism attached three cables to one side of a support post as shown in U.S. Pat. Nos. 7,398,960 and 7,364,137 to Neusch. Other cable guardrail systems positioned cables on opposite sides of the support posts in order to protect against impact from either side such as might occur when the system was installed in a highway median.

The state of the art in cable guardrail systems has been documented and applied through specifications used by the industry. The United States Department of Transportation Federal Highway Administration provides “Standard Specifications for Construction of Roads and Bridges on Federal Highway Projects,” including a section for cable guardrail systems and attachment mechanisms. Industry groups such as the American Association of State Highway and Transportation Officials (AASHTO), the Associated General Contractors (AGC) of America, and the American Road & Transportation Builders Association (ARTBA) have developed “A Guide to Standardized Highway Barrier Hardware” that included specifications for cable guardrails and posts. These specifications teach a cable guardrail system having a cable attached by hook-bolts and nuts to one side of a flanged-channel post. Additionally, agencies in both the United States and Europe have established guidelines for impact testing of safety barrier systems.

Prior cable guardrail systems had several drawbacks. Some cable attachments were difficult or costly to manufacture and install. Installation of cable guardrail systems exposes installation personnel to risks associated with working on or near active highways and roadways. Cable guardrail systems have been developed that reduce installation time thereby reducing the risk faced by installation personnel. There continues to be a need, however, for guardrail systems that reduce installation time and cost, and reduce risk to personnel.

A roadway guardrail system is disclosed comprising a plurality of posts capable of supporting at least one rod transverse to the posts, and at least one rod comprising one or more axially extending steel rods supported transverse to the plurality of posts. Each rod may comprise a plurality of axially extending steel rods supported transverse to the plurality of posts connected in a substantially end to end relationship.

The steel rods may be connected by couplers comprising a first portion and a second portion, each portion capable of receiving and securing the ends of adjacent steel rods. Alternately, the steel rods connected by welding. The steel rods may be rebar.

The steel rods may be between 20 and 60 feet in length, and may have a diameter between about 0.375 inches (9.53 mm) and 1.7 inches (43 mm). The steel rods may be treated with a coating. Alternately, the steel rods may be less than 20 feet (6 meters). In yet another alternative, the length of the steel rod is greater than 100 feet (30 meters). The roadway guardrail system may have at least one guardrail anchor capable of maintaining tension in the steel rod.

The plurality of posts may have a U-channel cross-section. At least one hook-bolt may be affixed to at least a portion of the plurality of posts supporting at least one steel rod transverse to the posts. Alternately or in addition, the roadway guardrail system may include a hanger supporting at least two rods transverse to the post, where the hanger includes a first portion having at least two seats each capable of supporting a steel rod, with first and second seats on opposite sides of the post, and a second portion capable of engaging the end of the post.

Also disclosed is a roadway guardrail system comprising a plurality of posts capable of supporting at least one rod transverse to the posts, and at least one rod comprising a plurality of axially extending steel rods connected in a substantially end to end relationship supported transverse to the plurality of posts. The steel rods may be connected by couplers comprising a first portion and a second portion, each portion capable of receiving and securing the ends of adjacent steel rods. Alternately or in addition, the steel rods may be connected by welding. The steel rods may be rebar.

Alternately, the roadway guardrail system may comprise a plurality of posts capable of supporting at least one steel rod transverse to the posts, a first anchor, a second anchor, and at least one rod comprising a plurality of axially extending steel rods connected in a substantially end to end relationship supported transverse to the plurality of posts between the first anchor and the second anchor.

The roadway guardrail system may be installed adjacent a roadway, such as along median strips, roadway shoulders, or any other path that is likely to encounter vehicular traffic, and may be capable of dissipating a portion of an impacting vehicle's energy and enabling an impacting vehicle to be redirected by the system.

### BRIEF DESCRIPTION OF THE DRAWINGS

Presently contemplated embodiments of the instant guardrail system are described below by reference to the following figures:

FIG. 1 is a perspective view of a roadway guardrail system;

FIG. 2 is a side elevation view of an anchor for a roadway guardrail system;

FIG. 3 is a perspective view of a coupler connecting steel rods;

FIG. 4 is a cross-sectional view of the coupler of FIG. 3;

FIG. 5 is a perspective view of an alternative coupler connecting steel rods;

FIG. 6 is a front view of a post;

FIG. 7 is a cross-sectional view through the post of FIG. 5;

FIG. 8 is a side view of a hookbolt;

FIG. 9 is a side view of a hanger;

FIG. 10 is a side view of an alternative hanger;

FIG. 11 is a side view of an alternative second portion of a hangar;

FIG. 12 is a side view of another alternative second portion of a hangar;

FIG. 13 is a side view of a third alternative hanger;

FIG. 14 is a side view of a fourth alternative hanger;

FIG. 15 is a side view of a fifth alternative hanger;

FIG. 16 is a side view of a sixth alternative hanger;

FIG. 17 is an end view of a clip;

FIG. 18 is a side view of the clip of FIG. 17; and

FIG. 19 is a side elevation view of a roadway guardrail system with the clip.

### DETAILED DESCRIPTION OF THE DRAWINGS

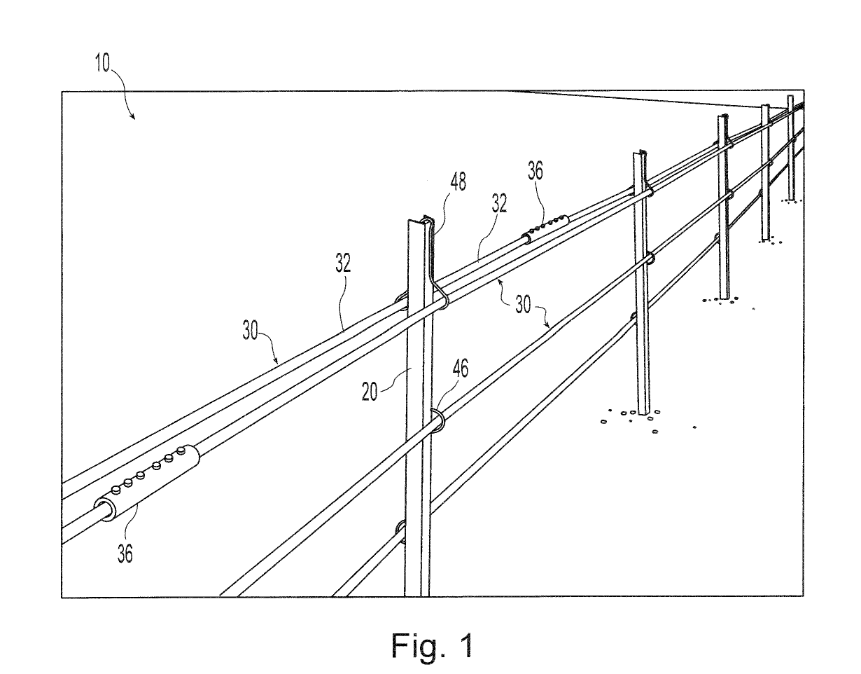

Referring generally to FIGS. 1 through 19, a roadway guardrail system 10 is disclosed operable to dissipate a portion of an impacting vehicle's energy and redirect the vehicle. The roadway guardrail system 10 may be installed adjacent a roadway along median strips, roadway shoulders, or at other locations likely to encounter vehicular traffic. As shown in FIG. 1, the roadway guardrail system 10 may comprise a plurality of posts 20 and at least one rod 30 transverse to the posts. As shown in FIG. 1, the guardrail system may have four rods 30. Alternately, the guardrail system 10 may have three rods 30, or two rods, or other number of rods 30 as desired. In the present guardrail system, the rod 30 may be an axially extending steel rod of a desired length. Alternately, the rod 30 may be a plurality of axially extended steel rods connected in a substantially end to end relationship. The steel rods may be rebar. Each end of the rods 30 of the guardrail system may be anchored such that the rods 30 are held in tension.

When the roadway guardrail system is installed along the side of a roadway, the system is capable of dissipating a portion of an impacting vehicle's energy and redirecting the impacting vehicle along the general direction of the roadway. As the vehicle impacts the roadway guardrail system, the rods 30 and posts 20 may deflect from the installed position. The deflection of the rods and the support posts may dissipate a portion of the vehicle's impact energy.

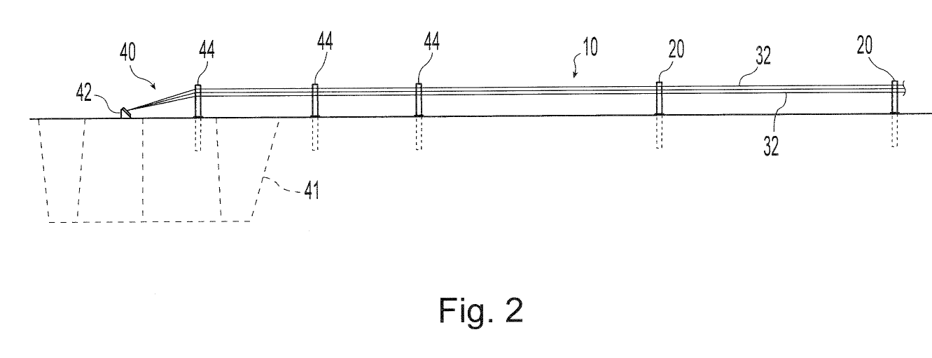

The roadway guardrail system may comprise at least one guardrail anchor 40 capable of maintaining tension in the rods 30, such as shown in FIG. 2. The guardrail anchors 40 may be operably positioned at either or both ends of the guardrail system. The guardrail anchor 40 may include a concrete foundation 41, one or more anchor brackets 42, and a plurality of slip posts 44. The anchor brackets 42 may be fastened to the concrete foundation using anchor bolts or other fasteners (not shown), and the steel rods are fastened to the anchor bracket via the slip posts. The plurality of slip posts may help to distribute the load of the tensioned rods 30. The end of the rod 30 may be attached directly to the guardrail anchor 40. Alternately, one or more cables may be connected between the end of the rod 30 and the anchor 40. Other embodiments of an anchor are contemplated by those skilled in the art, and the guardrail anchor shown in FIG. 2 is shown by way of example and not limitation.

As shown in FIG. 1, the rod 30 may have a plurality of axially extending steel rods 32 connected by fasteners or couplers 34. Alternately, the rods 30 may have a plurality of axially extending steel rods 32 connected by welding. The plurality of steel rods 32 are connected to form a continuous rod 30 corresponding to the desired length of the guardrail system 10. The steel rods 32 may be connected together in a substantially end to end relationship, or the ends of adjacent steel rods 32 may overlap. In an alternative embodiment, the rod 30 may have one continuous length of steel rod 32 corresponding to the desired length of the guardrail system 10. A plurality of steel rods 32 may be installed by attaching one or more steel rods 32 to the plurality of posts 20, and then fastening the steel rods together to form the continuous rod 30 corresponding to the desired length of the guardrail system 10. Alternatively, the steel rods 32 may first be fastened together, and then attached to the posts.

The steel rods 32 may be between about 20 and 60 feet (about 6 to 18 meters) in length, or may be shorter or longer as desired. The length of the steel rods 32 may be selected to accommodate various terrain and installation sites, shipping or transportation requirements, costs of materials, and other requirements. The rods may be cut to a specific length at the installation site or at another location. Depending on the length of the rods and the physical constraints of the installation site, the each rod 30 may comprise a single steel rod 32. In one alternative, the rods 30 may come from coils. The coils may be uncoiled and straightened at the installation site to form an extended length of rod 30, and may be between about 100 feet and about 500 feet (about 30 meters to about 150 meters). Alternately, the uncoiled and straightened rods may be between about 500 feet and about 3000 feet in length (about 150 meters to about 1200 meters), or longer. For example, a 2000 lb (about 900 kg) coil of 0.75 inch diameter (about 19 mm) rebar may be straighted to a length of about 1300 feet (about 400 meters).

The steel rods 32 may be approximately circular in cross section having a diameter between about 0.375 inches (9.53 mm) and 1.7 inches (43 mm) and a weight between about 0.37 and 7.7 pounds per foot of rod (between about 0.56 and 11.4 kilograms per meter). For certain applications, the rods may be between about 0.5 and 1.0 inches in diameter (about 12.5 to 25 millimeters) with a weight between about 0.67 and 2.7 pounds per foot of rod (about 1.0 to 4.0 kilograms per meter). Alternately, the steel rods 32 may be approximately square or rectangular in cross section, or may be other cross sectional shapes as desired.

The steel rods 32 may be rebar or other axially extending reinforcement bars. Rebar is a general term used to refer to steel bar that is typically used to reinforce concrete. Rebar may be smooth bar or deformed bar, where deformed bar includes deformations made on its surface to improve the mechanical bonding between the bar and the concrete. In the current application, the steel rods may be either smooth bar or deformed bar.

The steel rods 32 may be constructed of plain carbon steel having carbon content between about 0.4% and 1.0% by weight. Alternately, the plain carbon steel of the rods may have carbon content in a range between about 0.69% and 0.75% by weight. The rods may have a yield strength between about 40,000 lbs/in² (280 MPa) and about 75,000 lbs/in² (520 MPa), and a tensile strength between about 60,000 lbs/in² (420 MPa) and about 100,000 lbs/in² (690 MPa). Alternately, the rods may have a yield strength greater than about 60,000 lbs/in² (420 MPa) and a tensile strength greater than about 90,000 lbs/in² (620 MPa) The yield strength may allow the rods to provide sufficient support to resist the vehicle impact forces associated with an impact.

By way of example, and not limitation, the rods may be formed from U.S. new-billet steel, rail steel, or other types of steel alloys with the desired strength for the roadway guardrail system. Further, the rods may be treated with a coating. The coating may be selected to inhibit rust or corrosion of the steel, provide protection against the elements, improve the aesthetics of the guardrail, improve visibility of the guardrail, and/or provide durability. For example, the rods may have a coating such as polyester, epoxy, or other paint or polymer or other coating. Alternately or in addition, the rods may be hot-dip coated with zinc, aluminum, zinc-aluminum alloy or other coating to inhibit corrosion of the steel.

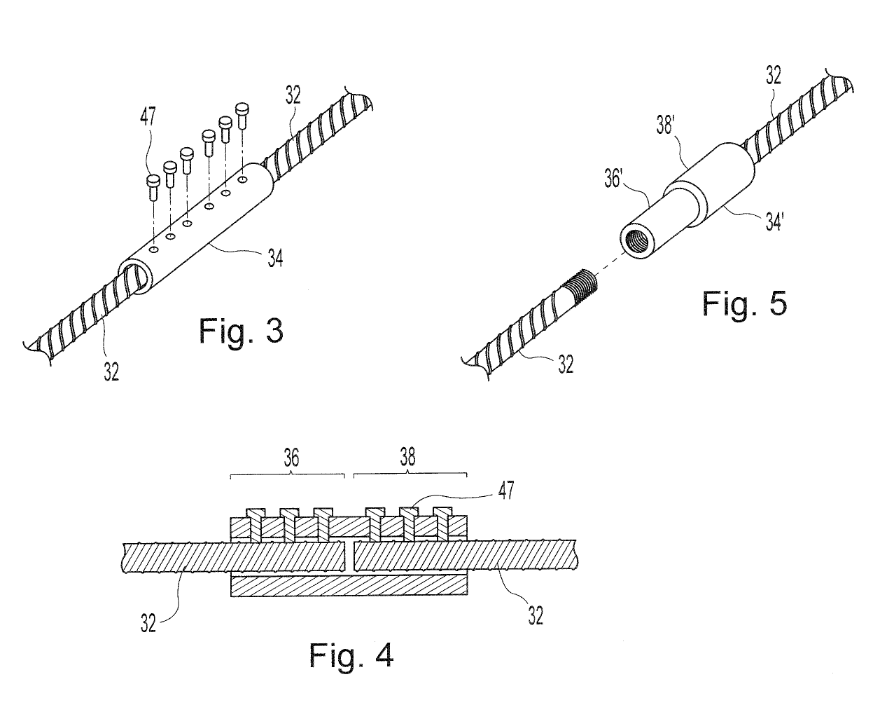

As shown in FIGS. 3 through 5, the couplers 34 may be capable of connecting adjacent steel rods 32 to form the rods 30. The couplers 34 may include a first portion 36 and a second portion 38, each portion capable of receiving and securing the ends of adjacent steel rods 32. The first portion 36 and the second portion 38 may be approximately aligned to connect adjacent steel rods 32 in a substantially end to end relationship. Alternately, the first portion 36 and the second portion 38 may be offset to connect adjacent steel rods 32 in an overlapping relationship (not shown). The couplers 34 may comprise clamping members 47 capable of securing the ends of the steel rods 32 in the first portion 36 and second portion 38. As shown in FIGS. 3 and 4, the clamping members 47 may include bolts, pins, rivets, or other clamping or fastening mechanisms. The clamping members 47 may be capable of releasing the steel rods. In one embodiment, the couplers are rebar couplers.

The rebar coupler 34 may function like a clamp. In the clamp configuration, the rebar coupler uses the clamping members 47 such as screws or other fastening devices to tighten a collar around two adjacent steel rods 32, as shown in FIGS. 3 and 4. Alternately or in addition, the rebar coupler 34 may be a threaded rebar coupler 34′, such as shown in FIG. 5. The threaded rebar coupler 34′ may include threaded first portions 36′ and threaded second portions 38′ such that two steel rods 32 are joined by forming threads on the ends of the steel rods 32 and screwing the threaded ends of the steel rods into corresponding threaded first portions 36′ and threaded second portions 38′ of the threaded rebar coupler 34′. Other rebar couplers capable of connecting adjacent steel rods may be used. The couplers 34, 34′ may be releasably attached to the steel rods. Alternately, the steel rod may be cut to disassemble the guardrail system.

Alternatively, two adjoining steel rods 32 may be welded together. In such a configuration, the couplers 34 comprise welds. The steel rods 32 may be assembled by butt welding in a substantially end to end relationship. Alternately, ends of the steel rods 32 may be welded in an overlapping position.

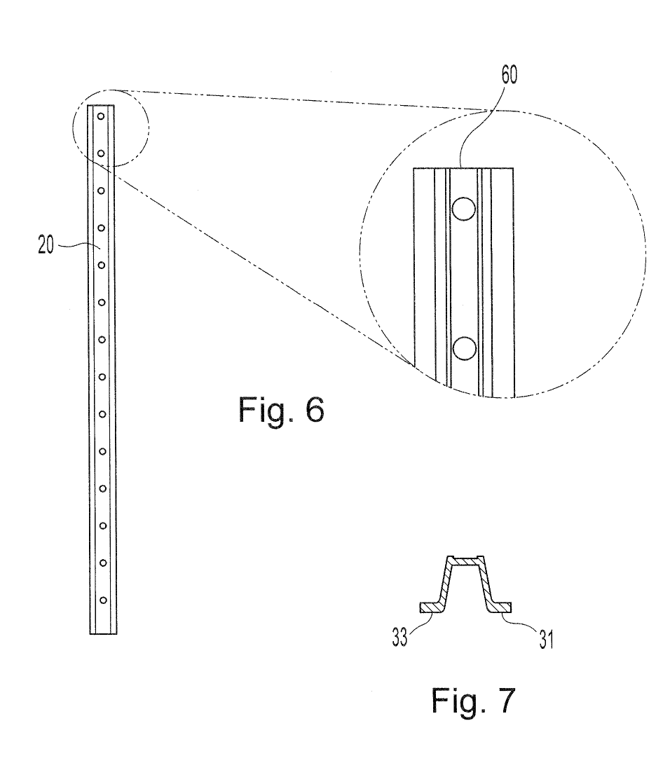

As shown in FIGS. 6 and 7, the support post may be constructed of plain carbon steel having carbon content between about 0.4% and 1.0% by weight. Alternately, the plain carbon steel of the support post may have carbon content in a range between about 0.69% and 0.75% by weight. The support post material may have yield strength between about 60,000 lbs/in² (415 MPa) and about 100,000 lbs/in² (690 MPa), and a tensile strength -greater than about 80,000 lbs/in² (550 MPa). Alternately, the support post may have a yield strength greater than about 60,000 lbs/in² (415 MPa) and a tensile strength greater than about 90,000 lbs/in² (620 MPa). The yield strength may allow the support post to provide sufficient support to resist the vehicle impact forces associated with an impact, and may then fracture to allow more energy to be absorbed.

The support post may have a weight between about 2 and 7 pounds per foot of post length (between about 2.9 and 10.4 kilograms per meter). Alternatively, the weight of the support post may be about 5 pounds per foot of post length (about 7.4 kilograms per meter). Prior steel support posts typically featured a weight of 8 pounds per foot of post length (about 11.9 kilograms per meter) or greater. Although these heavier support posts may be used, the support post of the present disclosure may reduce the weight of the support posts and the accompanying cost of the posts.

As shown in FIG. 7, the post may be generally defined as a U-channel post having a central web and formed with a dextral flange 31 and a sinistral flange 33 such that the post has a flanged, generally U-shaped cross-section. The post may be of a design similar to the U-channel metal posts currently offered by Nucor Marion Steel under the RIB-BAK® trademark. For example, the U-channel post may be about 2 inches (about 51 millimeters) deep and about 3½ inches (about 89 millimeters) wide. The weight of the U-channel post may be about 5 pounds per foot (about 7.44 kilograms per meter). Although the post may be shown as having a U-shaped cross-section, other configurations may be used as desired for a particular installation.

By way of example, and not limitation, the support post may be formed from U.S. new-billet steel, rail steel, or other types of steel alloys or other materials with the desired strength for the roadway guardrail system. Further, the support post may have a coating such as polyester, epoxy, or other paint or polymer or coating to provide durability and protection against rusting. Alternatively or in addition, the support post may be hot-dip coated with zinc, aluminum, chromate, zinc-aluminum alloy or other coating to provide protection against the elements.

Installation of the support posts may be completed using various techniques known in the art. One such example is a post driving machine. The particular technique used may depend upon the type of soil conditions and other factors associated with the roadway, and the type of road and other hazards involved in installation of the roadway guardrail system. The support posts may be installed with or without the use of metal foundation tubes or a concrete foundation.

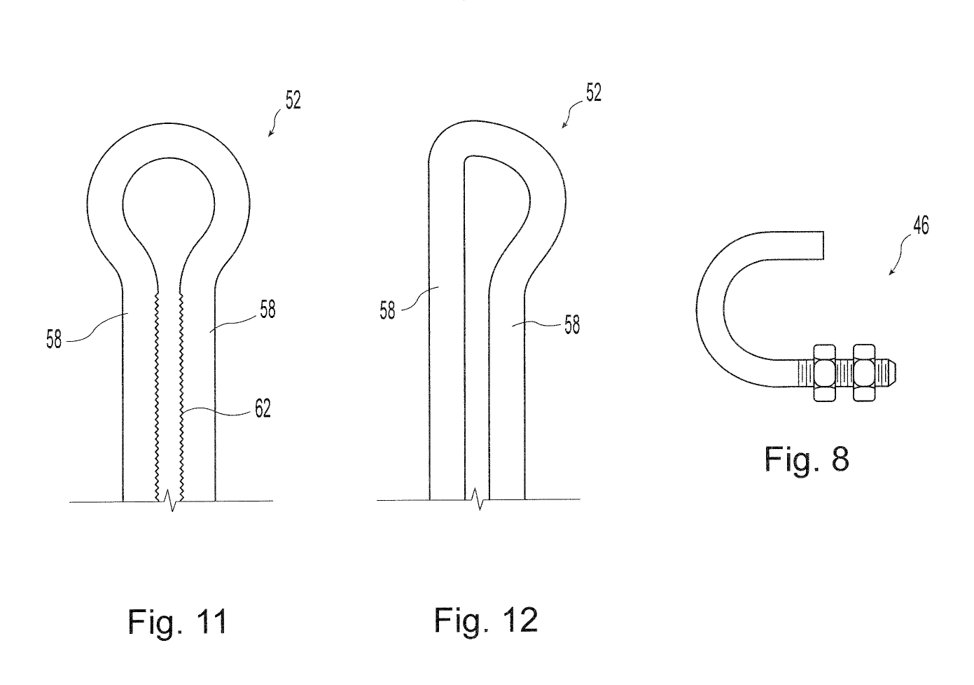

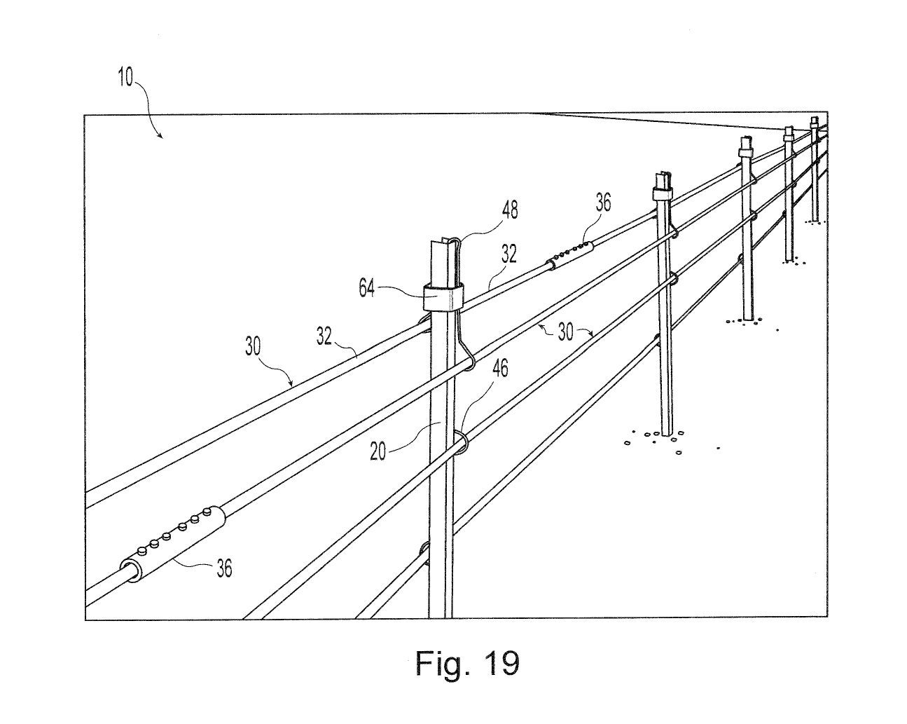

The rods 30 may be attached to the post 20 by fasteners, hangers, hooks, clamps, or other devices capable of securing the rod to the post. As shown in FIG. 1 and FIG. 19, a hook-bolt 46 may be used to secure the rods 30 to the posts 20. At least one hook-bolt 46, such as shown in FIG. 8 may be affixed to at least a portion of the plurality of posts to support at least one steel rod transverse to the posts. Other methods of fastening the rods 30 to the posts 20 are possible and are known to those skilled in the art. Such fasteners may be analogous to those used to attach cables to the support posts in prior cable guardrail systems.

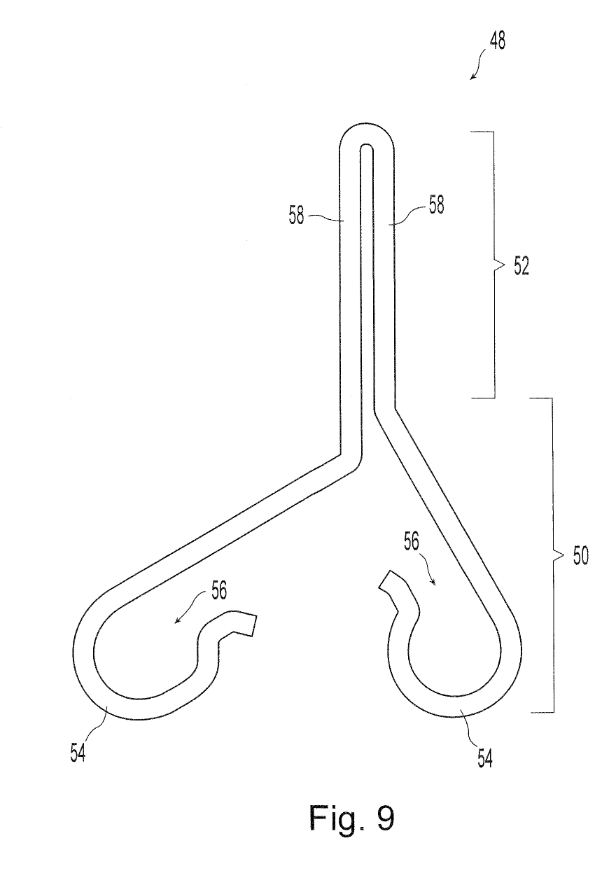

The steel rods 32 may be attached to the post using a hanger 48, such as shown in FIG. 9 capable of supporting two rods 30. The hanger 48 has a first portion 50 and a second portion 52. The first portion 50 has first and second seats 54 each capable of supporting the steel rods 32 adjacent the post. When installed on the post 20 the first and second seats 54 are provided on opposite sides of the post capable of engaging the steel rods 32. As shown in FIG. 9, the seats 54 may be formed as a rounded loop. Alternatively, the seats may be formed as hooks, rings, or other appropriate shapes capable of supporting a steel rod 32. The seats 54 may fully or partially encircle the rod. The seats 54 may also include features to secure the rod to the seat such as a latch, clasp, or similar mechanism. As shown in FIG. 9, the first portion may include a lead-in 56 having a shape for receiving the rods 30. The lead-in 56 may include a friction area providing resistance to the rod backing out of the seat.

The seats 54 may be formed in multiple ways. The seats 54 may be formed as an integral part of the first portion 50. Alternatively, the seats 54 may be formed as separate pieces and attached to the first portion 50, such as, but not limited to, by welding, crimping, fastening, interlocking, or another suitable attachment technique.

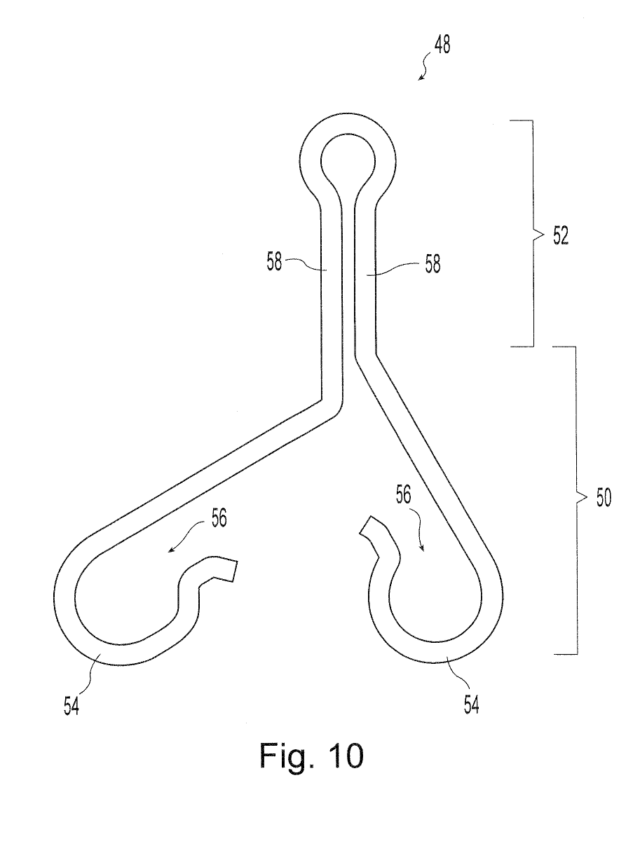

The second portion 52 of the hanger 48 is capable of engaging the end 60 of the post. The second portion 52 may be generally U-shaped as shown in FIG. 9, so that the second portion may slideably engage the end 60 of the post 20 in a top-down installation. The U-shaped second portion may have opposing sides 58, connected by an arcuate end such as shown in FIG. 10. Other forms of the second portion 52 are also contemplated. For example, the second portion 52 may have straight or tapered sides 58 that are substantially parallel or angular. The sides 58 may taper toward each other such that the sides provide a clamping force on the end of the post. In another example, the second portion may be shaped such that one side is substantially straight while the other side is bent, curved, or angular such as shown in FIG. 12. Various configurations of the second portion are contemplated to adapt to various post configurations such as U-channel, I-beam, box, and other post geometries. Additionally, the length of the sides may be selected to position the rods 30 at the proper height relative to the top of the post. The second portion may include friction enhancing surface characteristics in at least a portion 62 of the area contacting the post such as shown in FIG. 11. Such surface characteristics may also enhance the system's ability to dissipate energy and redirect an impacting vehicle. The friction enhancing surface characteristics may include virtually all types of surface patterns, such as but not limited to a grit blast texture, scored surface, serrated surface, grit-carrying coating, or other friction enhancing surface or coating.

The first portion 50 and the second portion 52 may be formed together out of one piece of material, such as shown in FIG. 9. Alternately, the first portion 50 and the second portion 52 may be separate pieces joined together, such as, but not limited to, by welding, crimping, fastening, interlocking, or other techniques. As separate pieces, the first portion and second portion may be of different materials as desired.

The hanger 48 may be formed from steel, in the form of sheet, bar stock, tube stock, or wire stock. Alternatively, the hanger may be formed from other metal or non-metal materials of suitable strength. The hanger 48 may be formed from steel of spring and/or other suitable specifications. Additionally, the hanger may have a coating to provide durability and protection against rusting in addition to engagement enhancement. The hanger may be hot-dip coated with zinc, aluminum, zinc-aluminum alloy or other coating to provide protection against the elements. Alternately, the hanger may be coated with a polymer or other paint coating for a protection against the environment.

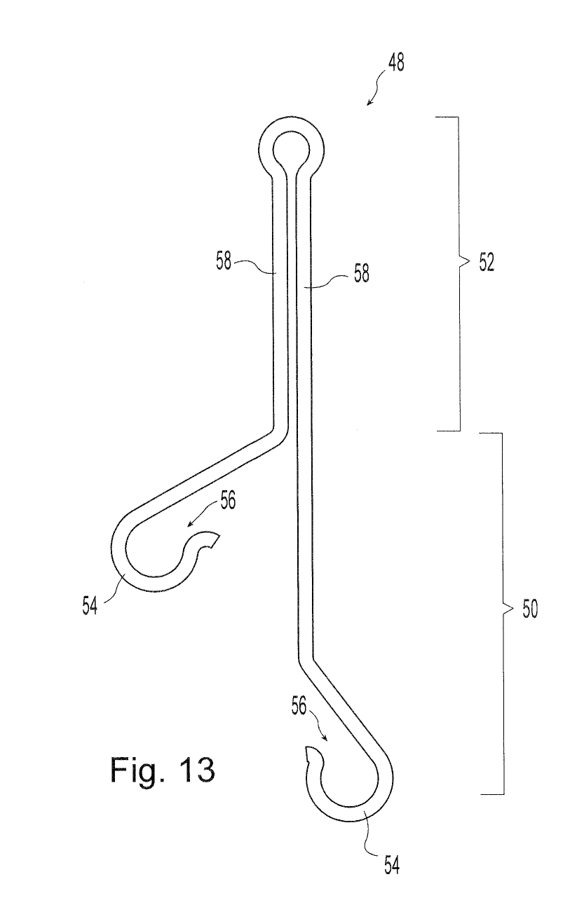

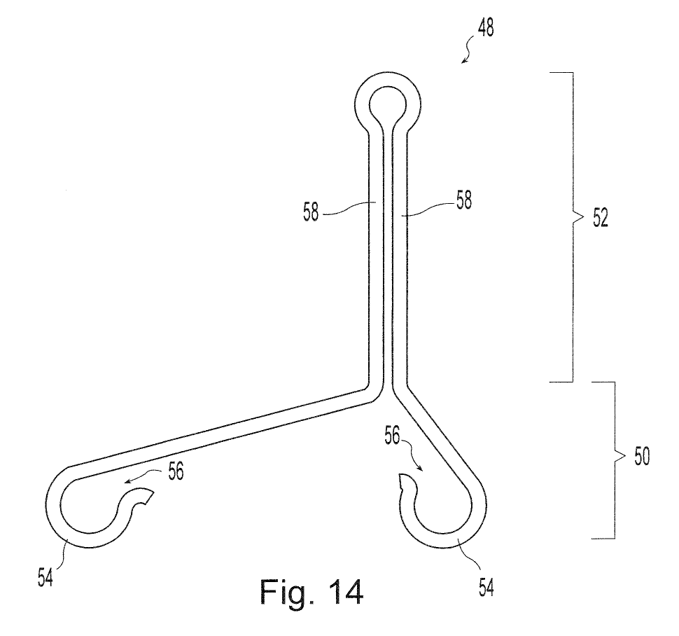

Other hanger configurations are also contemplated. As shown in FIG. 13, the seats may be positioned such that the first seat is closer to the end of the post than the second seat. In this configuration, the sides of the second portion may be of different lengths. This configuration may allow the rods 30 to be positioned at different heights relative to the ground. Alternatively, if the roadway guardrail system is installed on sloped ground the hanger 48 of FIG. 13 may permit the rods on opposite sides of the post to remain at approximately the same height relative to the ground. Another hanger is shown in FIG. 14 in which the first seat is laterally offset from the post. This configuration may be useful to provide greater separation between the post and the rod 30.

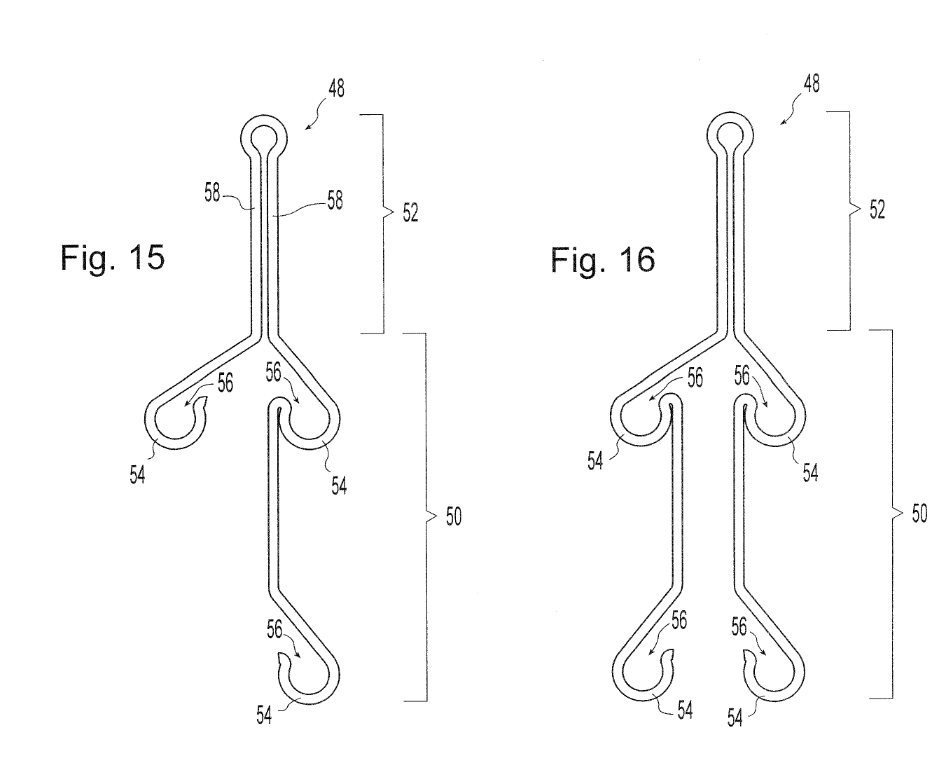

A further alternative hanger is depicted in FIG. 15 which shows a hanger with a third seat in addition to the first and second seats. This configuration permits one rod 30 to be supported on one side of the post, while two rods 30 are supported on the opposite side of the post. This hanger may be useful when the roadway guardrail system is installed between hazards of different size or height, or when greater protection is required on one side of the guardrail system. Additionally, this configuration may permit rods 30 to be placed at an appropriate height relative to the ground when the guardrail system is installed on sloped ground. A further alternative hanger is depicted in FIG. 16 which shows a hanger with a fourth seat positioned on the opposite side of the post from the third seat. Combinations and alterations of the above hanger configurations are also contemplated that may allow a hanger to be adapted to various posts and installation environments.

The roadway guardrail system 10 may have more than two rods 30. Additional rods may be supported by seats 54 in a hanger 48 such as that illustrated in FIGS. 15 and 16. Alternatively, additional rods may be supported by another rod attachment mechanism such as the hook-bolt 46 as shown in FIGS. 1, 8 and 19. One embodiment may include a first hook-bolt 46 capable of supporting a middle rod and second hook-bolt capable of supporting a lower rod, and alternative embodiments may include some posts where all cables are supported by hook-bolts or other attachment mechanisms. The middle and lower rods may be on the same side or on opposite sides of the post depending upon the requirements of the installation of the roadway guardrail system.

During installation or maintenance of a roadway guardrail system, the second portion of the hanger may slideably engage the end 60 of the post in a top-down installation. Additionally, the second portion may comprise the friction enhancing surface 62. A first rod 30 and a second rod may then be attached to the hanger 48 on opposite sides of the post 20. Such an installation may be faster and more efficient than installation of prior attachment mechanisms. Faster installations are less costly and reduce the time that installation personnel are exposed to the hazards alongside roadways. Further, maintenance of a roadway guardrail system may be improved because the hanger 48 may be removed and reattached.

Alternatively, a hanger may be attached to the first rod 30 and the second rod, then attached to the post 20. The second portion of the hanger may then slideably engage the end of the post in a top-down installation. By first attaching the hanger to the rods, the rods may assist in installing the hanger over the end of the post.

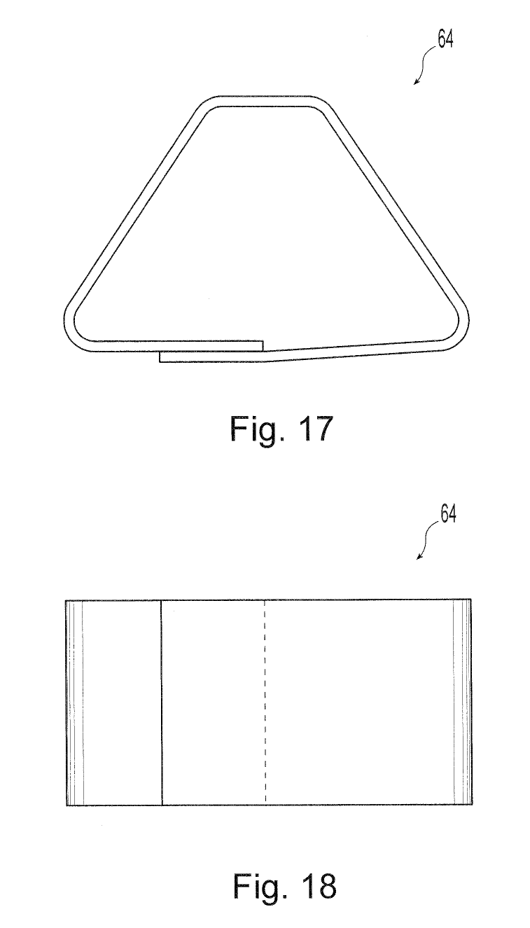

A clip 64, such as shown in FIGS. 17 through 19 may be slideably attached to the post. The clip 64 may assist in securing the hanger 48 to the post 20. The clip 64 may also assist in preventing the hanger 48 from separating from the post after installation, during maintenance, or during a vehicle impact.

The clip 64 may be formed from steel, in the form of sheet, bar stock, tube stock, or wire stock. Alternatively, the clip may be formed from other metal or non-metal materials of suitable strength. In one alternative, the clip 64 may be formed from steel of spring and/or other suitable specifications. Additionally, the clip 64 may have a coating to provide durability and protection against rusting and other environment conditions. The clip may be hot-dip coated with zinc, aluminum, zinc-aluminum alloy or other coating to provide protection against the elements. Alternately, the clip may be coated with a polymer or other paint coating.

The clip 64 may be installed over the end of the post after the hanger has been installed. The clip 64 may contact one or both sides of the second portion of the hanger. Alternately or in addition, the clip 64 may also contact the post 20. In one example, the clip may contact both the dextral flange and sinistral flange of a U-channel post.

When an errant vehicle impacts the roadway guardrail system, the post 20 and rods 30 at the point of impact may deflect from the installed position. As the deflection increases, the hanger 48 may release from the post so that the rods may remain in substantial contact with the errant vehicle. Friction enhancing surfaces on the second portion of the hanger or on the post may increase the energy dissipated as the hanger separates from the post. As the rods release from the posts, the overall deflection may increase. The spacing of posts and anchors may be adjusted to maintain the desired deflection of the roadway guardrail system during a vehicle impact.

We have found for certain installations the present guardrail system improved over cable guardrail systems in ease of installation, and may result in a lower cost over a similar cable system.

While the invention has been described with detailed reference to one or more embodiments, the disclosure is to be considered as illustrative and not restrictive. Modifications and alterations will occur to those skilled in the art upon a reading and understanding of this specification. It is intended to include all such modifications and alterations in so far as they come within the scope of the claims, or the equivalents thereof.

What is claimed is:

1. A roadway guardrail system comprising:
a plurality of posts capable of supporting at least one rod transverse to the posts; and
at least one rod comprising one or more axially extending steel rods supported transverse to the plurality of posts.

2. The roadway guardrail system of claim 1, each rod comprising a plurality of axially extending steel rods supported transverse to the plurality of posts connected in a substantially end to end relationship.

3. The roadway guardrail system of claim 2, the steel rods connected by couplers comprising a first portion and a second portion, each portion capable of receiving and securing the ends of adjacent steel rods.

4. The roadway guardrail system of claim 2, the steel rods connected by welding.

5. The roadway guardrail system of claim 1 where the steel rod is rebar.

6. The roadway guardrail system of claim 1 where the steel rods are between 20 and 60 feet in length.

7. The roadway guardrail system of claim 1, the steel rods having a diameter between about 0.375 inches (9.53 mm) and 1.7 inches (43 mm).

8. The roadway guardrail system of claim 1 where the steel rods are treated with a coating.

9. The roadway guardrail system of claim 1 where the length of the steel rod is less than 20 feet (6 meters).

10. The roadway guardrail system of claim 1 where the length of the steel rod is greater than 100 feet (30 meters).

11. The roadway guardrail system of claim 1 further comprising at least one guardrail anchor capable of maintaining tension in the steel rod.

12. The roadway guardrail system of claim 1 where the plurality of posts have a U-channel cross-section.

13. The roadway guardrail system of claim 1 further comprising at least one hook-bolt affixed to at least a portion of the plurality of posts supporting at least one steel rod transverse to the posts.

14. The roadway guardrail system of claim 1 further comprising:
a hanger supporting at least two rods transverse to the post comprising:
a first portion having at least two seats each capable of supporting a steel rod, with first and second seats on opposite sides of the post, and
a second portion capable of engaging the end of the post.

15. The roadway guardrail system of claim 14, where the first seat is positioned closer to the end of the post than the second seat.

16. The roadway guardrail system of claim 14, where the first seat is laterally offset from the post.

17. The roadway guardrail system of claim 14 further comprising a third seat on one side of the post in addition to the first and second seats.

18. The roadway guardrail system of claim 17 further comprising a fourth seat opposite the third seat.

19. The roadway guardrail system of claim 14, the second portion comprising a friction enhancing surface.

20. The roadway guardrail system of claim 14 further comprising a clip attached to each post.

21. The roadway guardrail system of claim 14 further comprising at least one hook-bolt affixed to at least a portion of the plurality of posts capable of supporting at least one rod.

22. The roadway guardrail system of claim 21 comprising two hook-bolts, where a first hook-bolt is capable of supporting a middle rod, and a second hook-bolt is capable of supporting a lower rod.

23. The roadway guardrail system of claim 22 where the middle rod and lower rod are on opposite sides of the posts.

24. A roadway guardrail system comprising:
a plurality of posts capable of supporting at least one rod transverse to the posts; and
at least one rod comprising a plurality of axially extending steel rods connected in a substantially end to end relationship supported transverse to the plurality of posts.

25. The roadway guardrail system of claim 24, the steel rods connected by couplers comprising a first portion and a second portion, each portion capable of receiving and securing the ends of adjacent steel rods.

26. The roadway guardrail system of claim 24, the steel rods connected by welding.

27. The roadway guardrail system of claim 24 where the steel rods are rebar.

28. The roadway guardrail system of claim 24 where the steel rods are between 20 and 60 feet in length.

29. The roadway guardrail system of claim 24, the steel rods having a diameter between about 0.375 inches (9.53 mm) and 1.7 inches (43 mm).

30. The roadway guardrail system of claim 24 where the steel rods are treated with a coating.

31. The roadway guardrail system of claim 24 where the length of the steel rods are greater than 100 feet (30 meters).

32. The roadway guardrail system of claim 24 further comprising at least one guardrail anchor capable of maintaining tension in the steel rod.

33. The roadway guardrail system of claim 24 further comprising at least one hook-bolt affixed to at least a portion of the plurality of posts supporting at least one steel rod transverse to the posts.

34. The roadway guardrail system of claim 24 further comprising:
a hanger supporting at least two rods transverse to the post comprising:
a first portion having at least two seats each capable of supporting a steel rod, with first and second seats on opposite sides of the post, and
a second portion capable of engaging the end of the post.

35. The roadway guardrail system of claim 24 where the plurality of posts have a U-channel cross-section.

36. A roadway guardrail system comprising:
a plurality of posts capable of supporting at least one steel rod transverse to the posts;
a first anchor,
a second anchor, and
at least one rod comprising a plurality of axially extending steel rods connected in a substantially end to end relationship supported transverse to the plurality of posts between the first anchor and the second anchor.

37. The roadway guardrail system of claim 36, the steel rods connected by couplers comprising a first portion and a second portion, each portion capable of receiving and securing the ends of adjacent steel rods.

38. The roadway guardrail system of claim 36, the steel rods connected by welding.

39. The roadway guardrail system of claim 36 where the steel rod is rebar.

40. The roadway guardrail system of claim 36 where the steel rods are between 20 and 60 feet in length.

41. The roadway guardrail system of claim 36, the steel rods having a diameter between about 0.375 inches (9.53 mm) and 1.7 inches (43 mm).

42. The roadway guardrail system of claim 36 where the steel rods are treated with a coating.

43. The roadway guardrail system of claim 36 where the length of the steel rod is greater than 100 feet (30 meters).

44. The roadway guardrail system of claim 36 further comprising at least one hook-bolt affixed to at least a portion of the plurality of posts supporting at least one steel rod transverse to the posts.

45. The roadway guardrail system of claim 36 further comprising:
a hanger supporting at least two rods transverse to the post comprising:
a first portion having at least two seats each capable of supporting a steel rod, with first and second seats on opposite sides of the post, and
a second portion capable of engaging the end of the post.

46. The roadway guardrail system of claim 36 where the plurality of posts have a U-channel cross-section.
